(19) United States
(12) Patent Application Publication
(10) Pub. No.: US 2026/0192394 A1
(43) Pub. Date: Jul. 9, 2026

(54) CONTROL METHODS FOR ENGRAVING DEVICE, ENGRAVING DEVICE, COMPUTER APPARATUS, STORAGE MEDIUM AND PROGRAM PRODUCTS

(71) Applicant: Beijing Zaowu Shidai Technology Co., Ltd., Beijing (CN)

(72) Inventor: Qiuxi ZHANG, Beijing (CN)

(73) Assignee: Beijing Zaowu Shidai Technology Co., Ltd., Beijing (CN)

(21) Appl. No.: 19/027,679

(22) Filed: Jan. 17, 2025

(30) Foreign Application Priority Data
Jan. 7, 2025 (CN) 202510025373.2

(51) Int. Cl. B23K 26/362

(52) U.S. Cl. CPC B23K 26/362

(57) ABSTRACT

Disclosed are controlling method for engraving device, engraving device, computer apparatus, storage medium, and program product. The method comprises controlling a head assembly to move over a probe device and clamp it from a probe base; controlling the head assembly to carry the probe device to probe material to be processed fixed to a workbench assembly to obtain material data; controlling the head assembly to carry the probe device to the probe base and release the probe device; and controlling the head assembly to move over and clamp a tool from tool base; controlling the tool to engrave the material based at least on the material data and the tool path file. By automating the control of the head assembly and the probe device, automatic acquisition of material data, tool length compensation and automated replacement of the tool are realized without manual operation by user.

### CROSS-REFERENCE TO RELATED APPLICATIONS

This application claims priority under 35 U.S.C. § 119 to Chinese Patent Application No. 202510025373.2 filed on Jan. 7, 2025, in the Chinese Patent Office, the entire contents of which are incorporated herein by reference.

### BACKGROUND

### Field

The present application relates to the technical field of engraving devices and, in particular, to control methods for engraving device, engraving devices, computer apparatus, storage media and program products.

### Description of Related Art

The engraving device in the existing technology needs to use a probe device to detect the material to be processed to obtain the detection data before the material is processed. Then the user needs to manually remove the probe device and install the required tool to carve the material to be processed. Therefore, this process requires manual participation in the operation, rendering a low degree of automation, reducing efficiency of engraving.

### SUMMARY

Embodiments of the present application provide a control method for engraving device, a computer apparatus, a storage medium, and a program product for solving at least one of the above technical problems.

In a first aspect, embodiments of the present application provide a control method for an engraving device, the engraving device comprising a head assembly and a workbench assembly, the head assembly being movable in a vertical direction and a transverse direction, and the workbench assembly being movable in a forward and backward direction, the vertical, transverse, and the forward and backward directions being perpendicular to each other, and the workbench assembly being provided with a probe device and a tool; the method comprising:
controlling the head assembly to move over the probe device and to clamp the probe device from the probe base;
controlling the head assembly to carry the probe device to probe material to be processed to obtain material data, the material to be processed being secured to the workbench assembly;
controlling the head assembly to move the probe device to and into the probe base;
controlling the head assembly to move over the tool and to clamp the tool from the tool base; and
controlling the tool to engrave the material to be processed, based at least on the material data and tool path file.

In some embodiments, the workbench assembly is further provided with a tool setter, and the method further comprises:
controlling the head assembly to carry the probe device vertically downward from a first predetermined height and record a first vertical travel distance when the probe device triggers the tool setter;
controlling the head assembly to carry the tool vertically downward from the first predetermined height and record a second vertical travel distance when the tool triggers the tool setter;
compensating the material data according to the first vertical travel distance and the second vertical travel distance for controlling the tool in conjunction with the tool path file to engrave the material to be processed.

In some embodiments, the method further comprises determining a Z-axis coordinate transformation relationship: Zₘ=Z_{L}−Z_{w}; wherein Zₘ is the current mechanical coordinate in Z-axis; Z_{L} is the mechanical coordinate in Z-axis at the time the probe device detects the highest point on the surface of the material to be processed and is triggered; and Z_{w} is the current Z-axis working coordinate.

In some embodiments, the compensating the material data according to the first vertical travel distance and the second vertical travel distance comprises tool length compensation using the equation of Zₘ=Z_{L}−Z_{w}−Z_{OFFSET}; wherein Z_{OFFSET} is the difference between the first vertical travel distance and the second vertical travel distance.

In some embodiments, the material to be processed is secured to the workbench assembly by an L-shaped positioning base plate, the method further comprising:
determining the inner corner point of the L-shaped positioning base plate as the zero point of the L-shaped positioning base plate, and determining a first relative positional relationship between the zero point and a predetermined mechanical coordinate zero point of the workbench assembly;
obtaining input of configuration data of origin of the work coordinate comprising a second relative positional relationship between the origin of the work coordinate and the zero point of the L-shaped positioning base plate; and
determining an XY plane coordinate transformation relationship between the work coordinate and the mechanical coordinate based on the first relative positional relationship and the second relative positional relationship.

In some embodiments, said controlling the cutter in conjunction with the cutter path file to engrave the material to be processed comprises:
obtaining current work coordinates based on the tool path file;
determining current mechanical coordinates based on the current work coordinates and the XY plane coordinate transformation relationship; and
controlling the head assembly carrying the tool to move to the current mechanical coordinates to engrave the material to be processed.

In some embodiments, the first relative positional relationship comprises a distance in the X-axis direction between the zero point of the L-shaped positioning base plate and the origin of the mechanical coordinates, a distance in the Y-axis direction between the zero point of the L-shaped positioning base plate and the origin of the mechanical coordinates; and
the second relative positional relationship comprises a distance in the X-axis direction between the origin of the work coordinate and the zero point of the L-shaped positioning base plate, and a distance in the Y-axis direction between the zero point of a work coordinate and the zero point of the L-shaped positioning base plate.

In some embodiments, the XY plane coordinate transformation relationship is expressed as the following equation:

Xₘ=X_{L}−X_{w}−X_{offset}; Yₘ=Y_{L}−Y_{w}−Y_{offset}, wherein
X_{L} is the distance in the X-axis direction between the zero point of the L-shaped positioning base plate and the origin of the mechanical coordinates;
Y_{L} is the distance in the Y-axis direction between the zero point of the L-shaped positioning base plate and the origin of the mechanical coordinates;
X_{offset} is the distance in the X-axis direction between the zero point of the working coordinates and the zero point of the L-shaped positioning base plate;
Y_{offset} is the distance in the Y-axis direction between the zero point of the working coordinates and the zero point of the L-shaped positioning base plate;
(X_{w}, Y_{w}) is the current work coordinate; (Xₘ, Yₘ) is the current mechanical coordinate.

In some embodiments, the method further comprises pre-storing mechanical coordinates of the probe device and the tool for controlling movement of the head assembly to the probe device or the tool.

In a second aspect, embodiments of the present application provide a computer apparatus comprising a memory, a processor, and a computer program stored on the memory, wherein the processor executes the computer program to implement the steps of the method of controlling a carving machine of any embodiment of the present application.

In a third aspect, embodiments of the present application provide an engraving device comprising a computing apparatus of any embodiment of the present application; a head assembly being movable in a vertical and lateral direction; a workbench assembly being movable in a forward and backward direction; the vertical, lateral and forward and backward directions being perpendicular to each other, the workbench assembly being provided with a probe device and a tool.

In some embodiments, a tool setter is also provided on the workbench assembly.

In a fourth aspect, embodiments of the present application provide a computer-readable storage medium having stored therein a computer program/instruction, wherein the computer program/instruction is executed by a processor to implement the steps of the controlling method for an engraving device of any embodiment of the present application.

In a fifth aspect, embodiments of the present application provide a computer program product comprising a computer program/instruction, wherein the computer program/instruction is executed by a processor to implement the steps of the method of controlling an engraving device of any embodiment of the present application.

The controlling method for an engraving device of an embodiment of the present application pre-sets a probe device and a tool on a workbench assembly, and realizes the automated replacement of the probe device and the cutter through the automated control of the head assembly. The whole process does not require manual operation by the user, which improves the efficiency of engraving and processing.

### BRIEF DESCRIPTION OF THE DRAWINGS

In order to more clearly illustrate the technical solutions of the embodiments of the present application, the accompanying drawings to be used in the description of the embodiments will be briefly introduced below, and it will be obvious that the accompanying drawings in the following description are some of the embodiments of the present application, and that for a person of ordinary skill in the field, other accompanying drawings can be obtained based on these drawings without inventive effort.

FIG. 1 shows a flowchart of an embodiment of a control method for an engraving device of the present application;

FIG. 2 shows a flowchart of another embodiment of control method for the engraving device of the present application;

FIG. 3 shows a schematic diagram of the application in which an L-shaped positioning base plate is used to fix the material to be processed;

FIG. 4 shows a schematic diagram of the internal structure of the tool setter of the present application;

FIG. 5a shows a schematic diagram of the internal structure of the tool setter of the present application (the black part is a schematic diagram of the upper barrel);

FIG. 5b shows a schematic diagram of the internal structure of the tool setter of the present application (the black part is a schematic diagram of the upper barrel);

FIG. 5c shows a schematic diagram of the internal structure of the tool setter of the present application (the black part is a schematic diagram of the sliding probe);

FIG. 5d shows a schematic diagram of the internal structure of the tool setter of the present application (the black part is a schematic diagram of the fixed contact);

FIG. 6a shows a schematic structure of the probe device of the present application;

FIG. 6b shows a schematic structural diagram of another view of the probe device of the present application;

FIG. 7a shows a schematic diagram of a structure of a probe assembly of the present application;

FIG. 7b shows a schematic structural diagram of another view of the probe assembly of the present application;

FIG. 8 shows a cross-sectional view of the probe device of the present application;

FIG. 9 shows a schematic diagram of a structure of the CNC machining equipment of the present application;

FIG. 10 shows a schematic structure of an embodiment of a computer apparatus of the present application.

### DETAILED DESCRIPTION

In order to make the purpose, technical solutions and advantages of the embodiments of the present application clearer, the technical solutions in the embodiments of the present application will be described clearly and completely in the following in conjunction with the accompanying drawings in the embodiments of the present application, and it is obvious that the described embodiments are a part of the embodiments of the present application and not all of the embodiments. Based on the embodiments in this application, all other embodiments obtained by a person of ordinary skill in the art without making inventive effort fall within the scope of protection of this application. It should be noted that the embodiments and the features in the embodiments in the present application can be combined with each other in case that no conflict exists.

It should also be noted that the terms “including” and “comprising” in this document include not only those elements followed, but also other elements that are not expressly listed, or that are inherent to such process, method, article or apparatus. Without further limitation, the recitation “including . . . ” does not exclude existence of other elements equivalent to an element included in the process, method, article or equipment defined by the recitation.

The present application provides a control method for an engraving device, which may be used in a control unit integrated inside the engraving device or configured outside the engraving device, which is not limited in the present application. The engraving device includes a housing, a head assembly, and a workbench assembly, the head assembly being movable in a vertical direction and a transverse direction, the workbench assembly being movable in a forward and backward direction. The vertical, transverse, and forward and backward directions are perpendicular to each other. The workbench assembly is provided with a probe device and a tool. The head assembly is used to install the probe device for probing the material to be processed. The head assembly may also be used to install a tool for engraving the material to be processed. The cutting tool may be a flat-bottomed cutting tool, a ball-ended cutting tool, a tapered flat-bottomed cutting tool, a tapered ball-ended cutting tool, a large-headed cutting tool, a drilling cutting tool, a laser cutting tool, and the like. It should be noted that the above tools are only examples, and the present application does not limit the specific types of tools. The above tools can be placed on a tool holder, which is set up on the working workbench assembly. In addition, the laser tool may be integrated on the head assembly in advance. Exemplarily, the laser tool may comprise a 2.5 W semiconductor laser module.

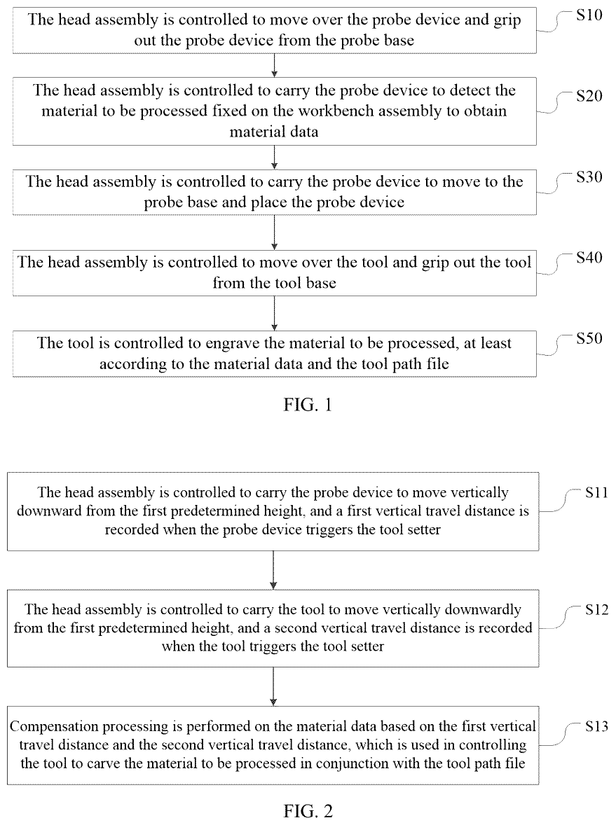

As shown in FIG. 1, embodiments of the present application provide a control method for an engraving device, which can be implemented by a control unit of the engraving device. The method includes the following steps.

In step S10, the head assembly is controlled to move over the probe device and clamp the probe device out from the probe base.

Exemplarily, positional information of the probe device on the workbench is prestored in the control unit of the engraving device. For example, coordinate information (e.g., mechanical coordinates) of the probe device on the workbench is pre-stored, such that under control of the control unit, the head assembly moves to the probe device, enabling automatic clamping of the probe device. In some embodiments, the control unit may simultaneously control the movement of the head assembly and the workbench assembly, such that the head assembly quickly reaches the probe device to achieve clamping of the probe device.

In step S20, the head assembly is controlled to carry the probe device to detect the material to be processed to obtain material data, the material to be processed being fixed on the workbench assembly. The material data includes data of origin of X, Y, and Z working coordinate of the material, as well as outer contour data of the material.

Exemplarily, the material to be processed is probed by the probe device to obtain data of origin of X, Y, and Z working coordinates and outer contour data of the material for use in engraving the material to be processed.

In step S30, the head assembly is controlled to carry the probe device to move to the probe base and place the probe device therein.

Exemplarily, positional information of the probe device on the workbench is pre-stored in the engraving device control unit. For example, coordinate information (e.g., mechanical coordinates) of the probe device on the workbench is pre-stored such that, under control of the engraver control unit, the head assembly moves to the probe base and then releases the probe device.

In step S40, the head assembly is controlled to move over the tool and clamps the tool out from the tool base. Exemplarily, positional information of the tool on the workbench is pre-stored in the control unit. For example, coordinate information of the tool on the workbench is pre-stored so that under control of the engraving device control unit, the head assembly moves over the tool to enable automatic clamping of the tool. In some embodiments, the control unit may simultaneously control the movement of the head assembly and the workbench assembly such that the head assembly quickly reaches the tool, realizing the clamping of the tool.

In step S50, the tool is controlled to engrave the material to be processed, at least according to the material data and the tool path file. The tool path file is pre-stored in the engraving device control unit. A plurality of tool path files can be stored for engraving different products.

The control method for an engraving device of an embodiment of the present application pre-sets a probe device and a tool on a workbench assembly, and realizes the automated replacement of the probe device and the tool through the automated control of the head assembly, and the whole process does not require manual operation by the user, which improves the efficiency of engraving and processing.

In some embodiments, tools may contain a plurality of cutters, the tool base is a cutter holder that can hold a plurality of cutters, and each cutter may be sequentially set with a number T0, T1, T2 . . . Tx. The tool number of the tool to be used is set in the tool path file when the user carries out the engraving process, and the engraving device control unit selects the corresponding tool according to the number in the tool path file.

The cutter holder is fixed on the engraving device workbench, so each cutter has a corresponding mechanical coordinate. The control unit accesses the selected cutter number in the user's tool path file to find the corresponding tool's mechanical coordinates, and then control the tool changer spindle (i.e., the head assembly) to move to the corresponding mechanical coordinates, achieving accurate clamping of the target tool.

In some embodiments, due to a difference in length between the probe device and the tool, switching to the tool to directly engrave the material to be processed after the probe device has finished probing can lead to engraving errors. Not only that, switching between tools of different lengths will also have the same problem. For this reason, the inventor has attempted to pre-store the length of the probe device and the tool in the control unit or directly store the length difference between the tool and the probe device for compensating the tool path data on the Z-axis direction according to the length difference after switching of the tools, to avoid the processing error caused by the length difference.

However, in the course of developing the embodiments of the invention, the inventor found that the automatic clamping of the tool or the probe device is realized by clamping of the clamping device at the lower end of the head assembly to the clamping shank at the upper end of the tool or the probe device. However, during the clamping process, the clamping shank may not be inserted into the clamping device in place, thereby introducing new errors. In order to solve this problem, the inventor proposes the following improvement scheme on the basis of the foregoing embodiments.

A flow diagram of another embodiment of the engraving device control method of the present application is shown in FIG. 2. In this embodiment, a tool setter is also provided on the workbench assembly, and the control method for the engraving device further comprises:

In step S11, the head assembly is controlled to carry the probe device to move vertically downward from the first predetermined height, and a first vertical travel distance is recorded when the probe device triggers the tool setter. The first predetermined height may be the highest point of the head assembly on the Z axis.

In step S12, the head assembly is controlled to carry the tool to move vertically downward from the first predetermined height, and a second vertical travel distance is recorded when the tool triggers the tool setter.

In step S13, compensation processing is performed on the material data based on the first vertical travel distance and the second vertical travel distance, which is used in controlling the tool to carve the material to be processed in conjunction with the tool path file. Exemplarily, a difference between the first vertical travel distance and the second vertical travel distance is determined as a compensation value, and the compensation value is utilized to perform the compensation processing on the material data (e.g., the compensation value is used to compensate the Z-axis coordinate origin in the material data).

In this embodiment, a tool setter is provided on the workbench assembly, and each time a tool is changed (the probe device is changed to a cutter or a cutter is changed to another cutter), the tool setter is used as a reference, and the trigger of the tool counter is used as a criterion to record the vertical travel distance, and according to the two vertical travel distances before and after the tool change (e.g., a first vertical travel distance and a second vertical travel distance), a relative difference is calculated and obtained, which is used to perform compensation processing for the material, thus avoiding engraving errors caused by improper installation of the tool head assembly to the probe device or tool clamping.

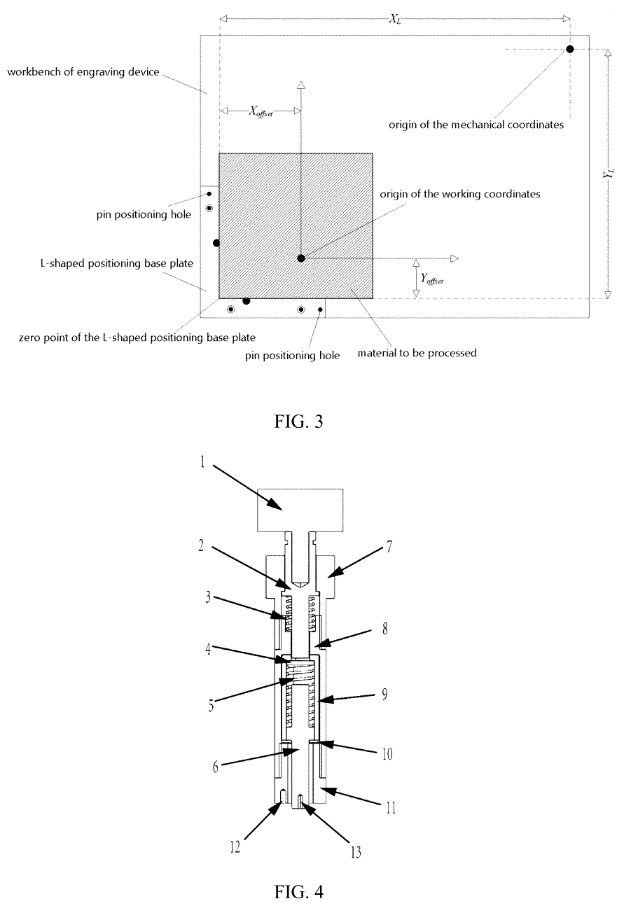

As shown in FIG. 3, a schematic diagram of the present application for fixing the material to be processed using an L-shaped positioning base plate, the L-shaped positioning base plate is provided with pin positioning holes, and the workbench of the corresponding engraving device is also correspondingly provided with pin positioning holes, both being fixed with screws. A control unit of the engraving device is preset in the L-shaped positioning base plate anchor point coordinates (that is, coordinates of the inner corner point in the L-shaped positioning base plate), thus in the use of the process, it is sufficient to have the material to be processed close to the L-shaped positioning base plate. The control unit automatically convert and determine the origin of the X-axis, Y-axis working coordinate. The advantage of this method is easy to use and accurate positioning, which can meet the requirement of conventional industrial positioning accuracy.

In some embodiments, the material to be processed can be secured to the workbench assembly by an L-shaped positioning base plate, and the method further comprise the following steps.

The inner corner point of the L-shaped positioning base plate is determined as zero point of the L-shaped positioning base plate, and a first relative positional relationship between the zero point of the L-shaped positioning base plate and a predetermined origin of mechanical coordinate of the workbench assembly is determined. The origin of the mechanical coordinate is the origin of the mechanical coordinate in the XY plane.

The configuration data of the origin of the work coordinate input by a user is obtained. The configuration data of the origin of the work coordinate includes a second relative positional relationship between the origin of the work coordinate and the zero point of the L-shaped positioning base plate zero point.

An XY plane coordinate transformation relationship between the work coordinates and the mechanical coordinates is then obtained based on the first relative positional relationship and the second relative positional relationship.

In some embodiments, controlling the tool to engrave the material to be processed in conjunction with the tool path file includes:
obtaining the current working coordinates according to the tool path file;
determining the current mechanical coordinates based on the transformation relationship between the current work coordinates and the XY plane coordinate; and
controlling the head assembly carrying the tool to move to the current mechanical coordinates for engraving the material to be processed.

In some embodiments, the first relative positional relationship includes: a distance between the zero point of the L-shaped positioning base plate and the origin of the mechanical coordinate in the X-axis direction, and a distance between the zero point the L-shaped positioning base plate and the origin of the mechanical coordinate in the Y-axis direction.

The second relative positional relationship includes: a distance between the origin of the working coordinate and the zero point of the L-shaped positioning base plate in the X-axis direction, and a distance between the origin of the working coordinate and the zero point of the L-shaped positioning base plate in the Y-axis direction.

In some embodiments, the transformation relationship of the XY plane coordinate is represented as the following equation:

Xₘ=X_{L}−X_{w}−X_{offset}; Yₘ=Y_{L}−Y_{w}−Y_{offset}; where
X_{L} is the distance between the zero point of the L-shaped positioning base plate and the origin of the mechanical coordinates in the X-axis direction;
Y_{L} is the distance between the zero point of the L-shaped positioning base plate and the origin of the mechanical coordinates in the Y-axis direction;
X_{offset} is the distance between the origin of the work coordinate and the zero point of the L-shaped positioning base plate in the X-axis direction;
Y_{offset} is the distance between the origin of the work coordinate and the zero point of the L-shaped positioning base plate in the Y-axis direction; and
(X_{w}, Y_{w}) is the current work coordinate; (Xₘ, Yₘ) is the current mechanical coordinate.

As shown in FIG. 3 the L-shaped positioning base plate is connected to the workbench of the engraving device by means of a pin, X_{L} is the distance between the zero point of the L-shaped positioning base plate and the origin of the mechanical coordinates in the X-axis direction, and Y_{L} is the distance between the zero point of the L-shaped positioning base plate and the origin of the mechanical coordinates in the Y-axis direction. Both X_{L} and Y_{L} are measured and calibrated before the machine is shipped out of the factory and are stored in the control unit of the engraving device.

X_{offset} is the distance between the origin of the work coordinate set by the user and the zero point of the L-shaped positioning base plate in the X-axis direction, and Y_{offset} is the distance between the origin of the work coordinate set by the user and the zero point of the L-shaped positioning base plate in the Y-axis direction. Both X_{offset} and Y_{offset} can be set by user in the interface of the control unit of the engraving device.

Let Xₘ and Yₘ be the current mechanical coordinates (i.e., the coordinates of the current work coordinate point under the mechanical coordinate system), and X_{w} and Y_{w} be the current work coordinates (i.e., the coordinates of the current work coordinate point under the work coordinate system, relative to the origin of the work coordinates), then the formula for calculating the work coordinates is:

$$\{ \begin{matrix}{X}_{w} = {X}_{L} - {X}_{m} - {X}_{- offset} \\ {Y}_{w} = {Y}_{L} - {Y}_{m} - {Y}_{- offset}\end{matrix} \qquad Equation 1$$

An equivalent transformation of Equation 1 gives the calculation of the current mechanical coordinates, as shown in Equation 2.

$$\{ \begin{matrix}{X}_{m} = {X}_{L} - {X}_{w} - {X}_{- offset} \\ {Y}_{m} = {Y}_{L} - {Y}_{w} - {Y}_{- offset}\end{matrix} \qquad Equation 2$$

The position where X_{w} is equal to 0 and Y wis equal to 0 is the origin of the work coordinates in the XY plane, the control unit of the engraving device control the engraving device spindle to move to the corresponding work coordinates according to the work coordinates in the tool path file for processing and based on the mechanical coordinates Xₘ, Yₘ calculated with Equation 2 to carry out the processing of the material.

In some embodiments, it is also necessary to determine the transformation relationship between the work coordinates in Z-axis and the mechanical coordinates in Z-axis so that the work coordinates in Z-axis are converted to the corresponding mechanical coordinates to control the movement of the head assembly on the Z-axis direction after obtaining the work coordinates in Z-axis from the tool path file.

The process of determining the transformation relationship between work coordinates in Z-axis and mechanical coordinates in Z-axis comprises: raising the head assembly to the highest point of the Z-axis, determining a point for detecting the origin of the work coordinate in Z-axis direction, and the control unit detects the origin of the work coordinate in Z-axis direction of the engraving device at the detection point. Wherein determining the point for detecting the origin of the work coordinate in Z-axis direction includes determining a point in the XY plane offsetting a preset value in the X-direction and the Y-direction as the detection point (e.g., a preset value of 5 mm for a material with a flat surface), or determining the detection point based on the highest point of the material surface (e.g., the highest point is determined as the detection point). Exemplarily, the automatic tool changer spindle (corresponding to the machine head assembly) is moved to the point for detecting the origin of the work coordinate in Z-axis, and the Z-axis is slowly moved downward until the coaxial probe (i.e., the probe device) contacts the surface of the material to be processed. If the coaxial probe is not triggered, an alarm message is generated; and if the coaxial probe is triggered, the origin of work coordinate in Z-axis is determined based on the current mechanical coordinates in Z-axis.

The mechanical coordinate in Z-axis is a distance relative to origin of the mechanical coordinate in Z-axis, and has the same meaning as the mechanical coordinates in X- and Y-axis. Exemplarily, the automatic tool changer spindle (corresponding to the head assembly) is movable up and down along the Z-axis, and the origin of the mechanical coordinate in Z-axis is the highest point of the automatic tool changer spindle (corresponding to the head assembly) on the Z-axis.

In some embodiments, the origin of work coordinate in Z-axis is determined based on the highest point on the surface of the material to be processed. For example, the automatic tool changer spindle carrying a probe device (e.g., a coaxial probe) starts from the highest point on the Z-axis and moves down along the Z-axis to the highest point on the surface of the material, and the distance Z_{L} traveled by the automatic tool changer spindle down along the Z-axis is recorded when the probe device is triggered, and the point on the Z-axis where the distance to the origin of the work coordinate on Z-axis is Z_{L} is the origin of the work coordinate on Z-axis.

Exemplarily, let Zₘ be the current mechanical coordinate on Z-axis, Z_{L} be the mechanical coordinate on Z-axis when the coaxial probe detects the highest point on the surface of the material to be processed and is triggered (in the case where the engraving device and the material to be processed are determined, this Z_{L} is a constant), and Z_{w} be the current working coordinate on Z-axis, then the formula for calculating the work coordinate is

$${Z}_{w} = {Z}_{L} - {Z}_{m} \qquad Equation 3$$

Equivalent transformation of Equation 3 leads to the calculation of Z-mechanical coordinates, as shown in Equation 4.

$${Z}_{m} = {Z}_{L} - {Z}_{w} \qquad Equation 4$$

The position where Z_{w} is equal to 0 is the origin of work coordinates on Z-axis, the control unit controls, according to work coordinates in the tool path file of processing and based on the mechanical coordinates Zₘ calculated by Equation 4, the engraving device's automatic tool changer spindle to move to the corresponding work coordinates to carry out the processing of the material.

In some embodiments, the origin of work coordinate on Z-axis is set by probing the highest point of the surface of the material to be processed on the Z-axis. In addition, a tool length compensation operation is performed to confirm the difference between the tool length and the coaxial probe length to ensure the accuracy of working position on Z-axis after changing to the machining tool. Let the automatic tool changer spindle use the coaxial probe to carry out the calibration operation, with the mechanical coordinates of Z-axis where the on-board detector (i.e., tool setter) is triggered being Z_{REF}, and the automatic tool changer spindle uses the actual tool to carry out the calibration operation, with the mechanical coordinates on Z-axis where on-board detector is triggered being Z_{TOOL}, the difference between the length of coaxial probe and the length of the actual tool being Z_{OFFSET}.

$${Z}_{OFFSET} = {Z}_{TOOL} - {Z}_{REF} \qquad Equation 5$$

Combining Equation 3 and Equation 5, the work coordinate on Z-axis after considering tool compensation is calculated as:

$${Z}_{w} = {Z}_{L} - {Z}_{m} - {Z}_{OFFSET} \qquad Equation 6$$

Equivalent transformation of Equation 6 leads to the calculation of mechanical coordinates on Z-axis after considering tool length compensation, as shown in Equation 7.

$${Z}_{m} = {Z}_{L} - {Z}_{w} - {Z}_{OFFSET} \qquad Equation 7$$

The control unit of the engraving device controls, according to the work coordinate in the tool path file of processing and based on the mechanical coordinates of Zₘ calculated by Equation 7, the engraving device's automatic tool changer spindle to move to the corresponding work coordinates to carry out the processing of the material.

In some embodiments, the steps of the present application for engraving the material to be processed include: the control unit of the engraving device reads instructions in the tool path file; turns on/off the spindle, moves to a specified position in the direction of the X, Y, and Z axes according to the instructions in the tool path file; and then reads next instructions in the tool path file to execute subsequently, until the instructions in the tool path file are finished being read.

In some embodiments, the present application may also enable leveling of the material, comprising the following steps:
The automatic tool changer spindle moves to the preset position of the first leveling point above the material;
The automatic tool changer spindle moves slowly down the Z-axis until the coaxial probe triggers;
Records the corresponding Z-axis height coordinate in the current X/Y coordinates;
All the points to be leveled have been detected, then the end; otherwise the automatic tool changer spindle moves to the next leveling point position above the material to continue the previous steps for detection.

In some embodiments, embodiments of the present application provide a computer apparatus comprising a memory, a processor, and a computer program stored on the memory, wherein the processor executes the computer program to implement the steps of the controlling method for an engraving device of any embodiment of the present application.

In some embodiments, embodiments of the present application provide a computer-readable storage medium having stored therein a computer program/instructions, wherein the computer program/instructions are executed by a processor to implement the steps of the control method for an engraving device of any embodiment of the present application.

In some embodiments, embodiments of the present application provide a computer program product comprising a computer program/instruction, and the computer program/instruction implements the steps of the control method for an engraving device of any embodiment of the present application when executed by a processor.

In some embodiments, embodiments of the present application provide an engraving device comprising:
the computer apparatus of any embodiment of the present application;
the head assembly being movable in a vertical and lateral direction;
a workbench assembly being movable in a forward and backward direction; the vertical, lateral, and forward and backward directions being perpendicular to each other, the workbench assembly being provided with a probe device and a tool.

In some embodiments, a tool setter is also provided on the workbench assembly.

A schematic diagram of the internal structure of the tool setter of the present application is shown in FIG. 4. This embodiment includes: a first barrel (e.g., upper barrel 7), a second barrel (e.g., lower barrel 8), a movable contact assembly, and a fixed contact assembly. A first space is defined between the upper barrel 7 and the lower barrel 8, and the movable contact assembly is mounted in the first space; a second space is formed in the lower barrel 8, and the fixed contact assembly is mounted in the second space. The first space and the second space are connected to each other, so that the movable contact assembly can be moved from the first position to the second position under an external force. The movable contact assembly is not in contact with the fixed contact assembly at the first position and the movable contact assembly is in contact with the fixed contact assembly at the second position to realize the first position. In the first position, the movable contact assembly and the fixed contact assembly are not in contact, and in the second position, the movable contact assembly is in contact with the fixed contact assembly to realize electrical connection.

This application integrates both the movable contact assembly and the static contact assembly into the tool setter, thereby avoiding the problem of CNC machining equipment carrying useless circuits for operation.

In some embodiments, the movable contact assembly includes a movable contact structure (e.g., a sliding probe 2) and a first resilient structure (e.g., a first-stage spring 3). The first-stage spring 3 maintains the sliding probe 2 in a first position when the sliding probe 2 is not acted upon by an external force, and the sliding probe 2 compresses the first-stage spring 3 and moves to a second position when the sliding probe 2 is acted upon by an external force.

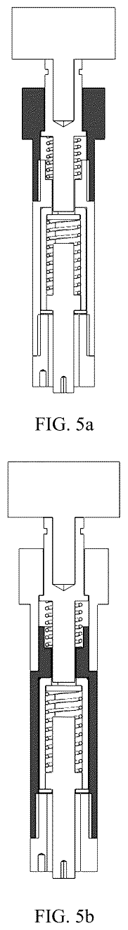

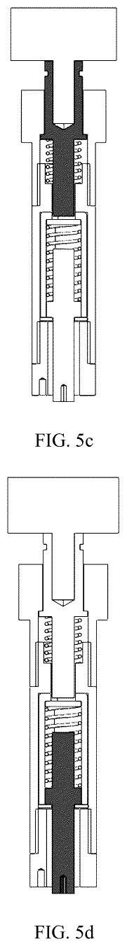

As shown in FIG. 5a, a schematic diagram of the internal structure of the tool setting apparatus of the present application is shown (the black part is a schematic diagram of the upper barrel 7). As shown in FIG. 5b, a schematic diagram of the internal structure of the tool setting apparatus of the present application is shown (the black part is a schematic diagram of the upper barrel 8). The lower end of the upper barrel 7 is mounted in conjunction with the upper end of the lower barrel 8, the lower end of the first stage spring 3 is in contact with the upper end of the lower barrel 8, and the upper end of the first stage spring 3 is in contact with the sliding probe 2. The body of the sliding probe 2 is provided with a circumferential tab, the first-stage spring 3 is snapped over a body portion of the sliding probe 2 disposed below the circumferential tab, and is in contact with a lower surface of the circumferential tab on the body of the sliding probe 2. The body portion of the sliding probe 2 disposed above the circumferential tab passes through an upper opening of the upper barrel 7 and the upper opening of the upper barrel 7 is smaller than the dimensions of the circumferential tab, so that the inner wall of the upper barrel in the upper barrel 7 is tabbed and fits into the circumferential tab. Under the action of the first stage spring 3, the upper surface of the circumferential tab is in contact with the inner wall tab of the barrel.

As shown in FIG. 5c, a schematic diagram of the internal structure of the tool setting apparatus of the present application is shown (the black part is a schematic diagram of the sliding probe 2). A tool catching platform 1 is also mounted on the main body portion of the sliding probe 2 located above the circumferential convex platform, and a tool or a probe device of the CNC machining equipment realizes tool setting by connecting with the tool catching platform 1. The tool catching platform 1 may be connected to the main body portion of the sliding probe 2 disposed above the circumferential convex platform by a threaded connection, and other connection methods may also be used, which are not limited by the present application.

The lower end of the upper barrel 7 and the upper end of the lower barrel 8 can be installed in a manner of threaded connection or welding or riveting, etc., and the present application does not limit this. The upper barrel 7, the lower barrel 8, the sliding probe 2, and the primary spring 3 are made of electrically conductive material.

As shown in FIG. 5d, a schematic diagram of the internal structure of the tool setter of the present application is shown (the black portion is the fixed contact shown intended). In some embodiments, the fixed contact assembly includes a fixed contact structure (e.g., fixed contact 6) and a cushion structure in contact with the fixed contact structure. When the movable contact structure (e.g., sliding probe 2) is moved to the second position, the movable contact structure contacts the cushioning structure, and the cushioning structure realizes an electrical connection between the movable contact structure and the static contact structure.

The cushioning structure includes a cushioning contact 4 and a second resilient structure (e.g., a secondary spring 5). A first end of the secondary spring 5 is in contact with the fixed contact 6, and the buffer contact 4 is mounted on a second end of the secondary spring 5. A coefficient of elasticity of the primary spring 3 is less than a coefficient of elasticity of the secondary spring 5.

The fixed contact assembly is provided with an insulating layer between the fixed contact assembly and the second barrel (lower barrel 8), which insulating layer includes an insulating ring 9; the movable contact assembly is connected to the external circuit through the second barrel (lower barrel 8), and the fixed contact assembly is connected to the external circuit through the end of the fixed contact structure away from the movable contact structure.

As shown in FIG. 4, the tool setting device of the present application further includes a base lug nut 11 mounted at an end of the lower barrel away from the movable contact assembly, a circumferential projection structure is provided in the middle of the fixed contact 6, and the base lug nut 11 restricts the fixed contact 6 through the circumferential projection structure to complete the installation of the fixed contact in the second space. The upper end of the lower barrel 8 is provided with a through-hole for the body of the sliding probe 2 to pass through, a diameter of the through-hole being smaller than the diameter of the second space, a diameter of the secondary spring 5 being larger than the diameter of the through-hole, or a diameter of the cushioning contact 4 being larger than the diameter of the through-hole, so as to form a lower barrel inner wall boss inside the lower barrel 8 for confining the cushioning structure (i.e., the cushioning contact 4 and the secondary spring 5) within the second space.

The secondary spring 5 is set over the body of the fixed contact 6, the upper end of the secondary spring 5 is pressed against or connected to the buffer contact 4, and the lower end of the secondary spring 5 is pressed against the upper surface of the circumferentially raised structure of the fixed contact 6. Further, an insulating sheet 10 (e.g., an annular insulating spacer) is provided between the base lug nut 11 and the lower surface of the circumferential raised structure of the fixed contact 6.

The chassis wiring nut 11 is provided with a through-hole through which an end of the fixed contact 6 away from the movable contact assembly passes. The fixed contact 6 has a clearance between the fixed contact 6 and the inner wall of the through-hole, ensuring insulation between the fixed contact 6 and the chassis wiring nut 11.

Wiring holes are provided at the lower ends of both the base wiring nut 11 and the fixed contact 6 for realizing electrical connections of the movable contact assembly and the fixed contact assembly in the tool setter with an external circuit. For example, in the case that the tool catching platform 1 is not subjected to a force, the movable contact assembly is in a first position, maintaining a separated state from the fixed contact assembly. The sliding probe 2 in the movable contact assembly is electrically conductive connected to the lower barrel 8 through the first spring 3, and the base wiring nut 11 is electrically connected to the lower end of the lower barrel 8, and then is connected to the external circuit through a wire. The fixed contact 6 is directly connected to the external circuit through a wire. When the tool catching platform 1 is subjected to a force, the sliding probe 2 is moved downwardly and comes into contact with the buffer contact 4, the buffer contact is electrically connected to the fixed contact through the secondary spring 5, and thus the fixed contact 6 is electrically connected. The buffer contact is electrically connected to the fixed contact 6 through the secondary spring 5, thereby realizing the closed-loop connection of the movable contact assembly and the fixed contact assembly with the external circuit.

As shown in FIG. 4, the upper barrel 7 and lower barrel 8 base lug nuts 11 in this application form the overall housing of the tool setter. The fixed contact 6, buffer contact 4, insulating ring 9, insulating sheet 10 are normally at rest under the tension of the secondary spring 5 and the binding of the overall housing.

The fixed contact 6 and the buffer contact 4 are subjected to the tension of the secondary spring 5 in any working state, so the fixed contact 6 and the buffer contact 4 are electrically connected in any working state. The fixed contact 6, the buffer contact 4, and the secondary spring 5 are subjected to the all-encompassing insulation of the insulating ring 9 and the insulating sheet 10 in any operating state, so the fixed contact 6, the buffer contact 4, the secondary spring 5 and the overall housing are electrically disconnected in any operating state.

The tool catching platform 1 is stably connected to the sliding probe 2 and is normally stationary under the first spring 3 and the overall housing. The receiver platform 1 and the overall shell is not insulated so the tool catching platform 1 and the overall shell is electrically connected. When the tool catching platform 1 is under the external vertical downward force extrusion, the tool catching platform 1 and the sliding probe 2 together compress the first spring 3 to realize a vertical downward displacement.

When the lower surface of the sliding probe 2 touches the movable contact 4, the tool catching platform 1 is electrically connected to the fixed contact 6. At this time, the wires and other circuits connected to the external terminal hole 12 and internal terminal hole 13 of the insulation layer are also electrically connected, and a feedback signal is generated.

The secondary spring 5 has the following functions:

The first one is to play a buffer effect on the part of the downward moving tool catching platform 1 and sliding probe 2, avoiding occurrence of rigid contact and damage to the tool setting parts and tools as well as affecting the accuracy of tool setting.

Secondly, when the sliding probe 2 contacts the movable contact 4, there is still a period of downward movement between the upper surface of the fixed contact 6 and the bottom surface of the movable contact 4. If due to some accidents the sliding probe 2 do not retract after contacting the movable contact 4 but still continue to move down, the secondary spring 5 can always hold the movable contact 4 so that it always contacts the lower surface of the sliding probe 2 to ensure that the fact that the tool has been in contact with the cutter receiving platform 1 is actually feedback in the mechanism.

A distance is provided between the upper end surface of the fixed contact 6 and the bottom surface of the movable contact 4, which has the advantage of avoiding rigid contact to provide a cushioning space.

When the external force on the tool receiving platform 1 disappears, the first spring 3 and the secondary spring 5 return to deformation, the internal movable parts of the entire tool setter return to normal, the wires connected to the wiring holes 12 and wiring holes 13 are electrically disconnected, the feedback signal disappears.

In some embodiments, the present application further provides a CNC machining apparatus configured with a probe device and the tool setter of any of the preceding embodiments.

In the prior art, before operating a CNC machining apparatus (e.g., a 3D engraving device) to process a part, an operator needs to probe the material to be processed to determine information such as the boundary of the material to be processed, so as to facilitate the realization of automated machining based on the machining target. In the course of realizing the present application, the inventor found that an operator, when detecting the material to be processed by means of a probe, needs to manually control the movement of the probe in three-dimensional space in order to detect a target point on the material to be processed. For example, for a small groove on the processed material, the groove needs to be enlarged or deepened, the operator needs to manually adjust the movement of the probe in the front-back and left-right directions, and then tentatively adjust the height of the probe, and then align the probe to the groove. The whole process is time-consuming and laborious, and requires high degree of operation proficiency for the operator. The present application provides a probe device which solves the above problems to a certain extent.

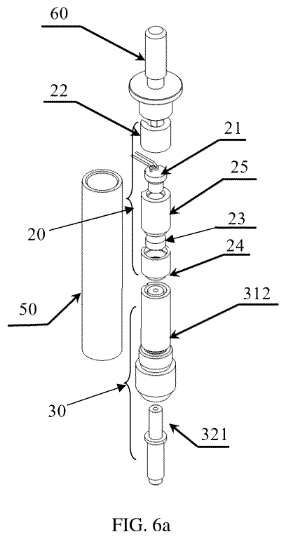

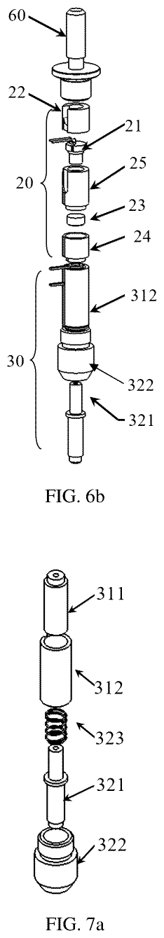

As shown in FIGS. 6a, 6b, and 8, an embodiment of the application provides a probe device for use in a CNC machine. The probe device includes a housing 10′, a light source assembly 20, a probe assembly 30, and a circuit board 40 assembled in the housing 10′.

The circuit board 40 is connected to the light source assembly 20 and the probe assembly 30.

The light source assembly 20 is provided at one end of the probe assembly 30, and the light source assembly 20 is configured to indicate a probe point of the probe assembly 30;

The probe assembly 30 is provided with an optical channel used for light emitted by the light source assembly 20 to pass through to indicate the probe point of the probe assembly 30.

Exemplarily, the light source assembly 20 is provided at an upper end of the probe assembly 30, and light emitted from the light source assembly 20 may be projected onto the surface of the material to be processed through a light channel provided in the probe assembly 30 to indicate a probe point of the probe assembly 30 on the material to be processed.

The embodiment of the present application indicates the probe point of the probe assembly 30 by the light source assembly 20 in the probe device, which facilitates the operator to quickly locate the landing point of the probe assembly 30 on the object to be processed, simplifies the operation steps, and improves the probing efficiency.

In some embodiments, the light source assembly 20 includes a light source 21 and a light source mount 22 for mounting the light source 21, the light source 21 being at least partially embedded in the light source mount 22 and electrically connected to the circuit board 40. Exemplarily, the light source 21 may be an infrared light source, the light source 21 is provided with two electrodes, the two electrodes are used for connecting to the circuit board 40 to realize the control of power on and off of the light source 21 by means of the circuit board 40, thereby realizing the switching of the light source 21. Exemplarily, the circuit board 40 is provided with a controller for controlling the switching of the light source 21.

In some embodiments, the light source assembly 20 further includes a convex lens 23 and a lens mount 24, the convex lens 23 being provided between the light source 21 and the probe assembly 30 via the lens mount 24 to direct light from the light source 21 to the optical channel. Exemplarily, the convex lens 23 which is circular is embedded in the lens mount 24 which is correspondingly a circular mount. The lens mount 24 is provided with a through-hole to allow light from the convex lens to pass through. The setting of the convex lens 23 in the light source assembly 20 can realize the convergence of the light emitted from the light source 21, so that the light can be better directed to the probe assembly 30, realizing more stable and clearer indication of the probe point of the probe assembly 30 on the material to be processed.

In some embodiments, the light source assembly 20 further includes a focal length limiting member 25 provided between the light source 21 and the convex lens 23. Exemplarily, the focal length limiting member 25 is in the form of a cylinder, e.g., the focal length limiting member 25 is a lens focal length cylinder. The length of this focal length limiting member 25 may be set according to the focal length of the convex lens, so as to enable the light emitted from the light source 21 to be accurately projected to the optical channel in the probe assembly 30 after passing through the convex lens 23.

Exemplarily, the shape of the light source mount 24 matches the light source 21. For example, the light source 21 is at least partially cylindrical, and the corresponding light source mount 24 has a cylindrical outer contour and is internally provided with a through-hole, which is used to mount the light source 21. Further, in order to facilitate the mounting of the electrodes on the light source 21, a notch is provided on a side wall of the light source mount 24, which is used for the connection of the two electrodes of the light source 21 to an external realization (e.g., a connection to the circuit board 40 is realized by means of wires).

In some embodiments, a lower portion of the light source 21 is embedded in the focus limiting member 25 and an upper portion of the light source 21 is embedded in the light source mount 24. The focus-limiting member 25 is tubular, and an axis of the focus-limiting member 25 is co-linear with an axis of the light source mount 24.

Exemplarily, the light source 21, the focus limiting member 25, the convex lens 23 and the convex lens mount 24 are assembled together sequentially from top to bottom, and the assembly is realized by inline connection or threaded connection or adhesion or the like between each other, which are not limited in the present application. The axes of the light source 21, the focal length limiting member 25, the convex lens 23 and the convex lens mount 24 are co-linear.

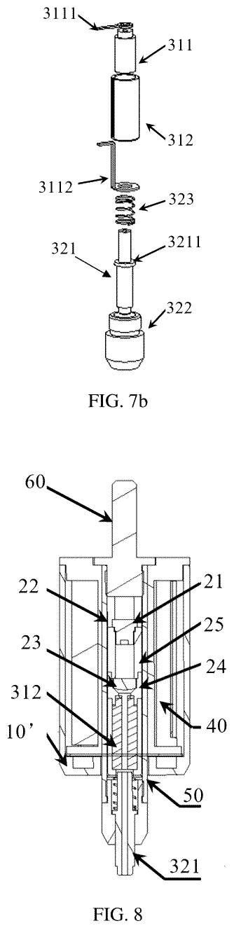

As shown in FIG. 7a, FIG. 7b, and FIG. 8, in the probe device provided in the present application, the probe assembly 30 includes a static contact assembly 31 and a movable contact assembly 32, and the static contact assembly 31 and the movable contact assembly 32 are connected to the circuit board 40.

Detection of the probing action of the probe assembly is realized in this application by connecting the static contact assembly 31 and the movable contact assembly 32 to the circuit board 40. For example, when the movable contact assembly 32 is displaced in contact with the material to be processed, thereby making contact between the movable contact assembly 32 and the static contact assembly 31 to form a closed loop that generates a detection signal in the circuit board 40 indicating that the probing is in place.

In some embodiments, the static contact assembly 31 includes a static contact portion 311 and a static contact insulating portion 312, the static contact portion 311 being embedded in the static contact insulating portion 312, and the static contact portion 311 being coupled to the circuit board 40. Exemplarily, the centers of both the static contact assembly 31 and the movable contact assembly 32 are provided with through holes to form an optical channel. As shown in FIG. 7b, in this embodiment of the present application, the static contact assembly 31 further includes a first probe electrode 3111, wherein one end of the first probe electrode 3111 is in contact with the static contact portion 311, and the other end of the first probe electrode 3111 is connected to the circuit board 40.

In some embodiments, the movable contact assembly 32 includes a probe 321, a probe mount 322, and a probe reset spring 323. The body of the probe 321 is provided with a probe snap-in portion 3211. The probe mount 322 is provided with a through-hole for assembling the probe 321. The through-hole is provided with a probe limit portion that is mated with the probe snap-in portion 3211 (e.g., the probe limit portion may be a tab, or realized as a gradually decreasing diameter of the lower end of the probe mount to realize the snap of the probe). A first side surface of the probe catch portion 3211 interoperates with the probe limit portion, and a second side surface of the probe catch portion 3211 interoperates with the probe reset spring 323, with the first side surface and the second side surface opposite each other. The probe reset spring 323 is triggered to deform when the probe 321 is subjected to an external force of a predetermined range. Exemplarily, the predetermined range may be 0.1 N-0.2 N. Since the probe reset spring 323 will trigger the deformation with only a small external force, even a material with a soft texture during the touching of the tip of the probe 321 with the material to be detected will almost never produce deformation on the contact surface that affects the detection accuracy. Therefore, the material need not be limited to metal, plastic, wood and other relatively hard materials.

Exemplarily, the probe catch portion 3211 is provided near the middle of the probe 321, and the probe catch portion 3211 may be a single integral part circumferentially surrounding the probe 321 or a plurality of subparts spaced apart circumferentially surrounding the probe 321, which is not limited by the present application.

The movable contact assembly 32 further includes a second probe electrode 3112, wherein one end of the second probe electrode 3112 is in contact with the probe 321 and the other end of the second probe electrode 3112 is connected to the circuit board 40.

In some embodiments, a general assembly barrel 50 for assembling the light source assembly 20 and the probe assembly 30 is also included, the general assembly barrel 50 being provided with a general assembly through-hole in the direction of the optical channel, and the probe mount 322 being at least partially embedded in the general assembly barrel 50.

In this embodiment, the light source assembly 20 and the probe assembly 30 are coaxially assembled by means of the general assembly barrel 50, which ensures the reliability of the assembly and avoids the problem that the light cannot pass through smoothly due to the mutual misalignment of the components.

In some embodiments, the static contact insulating portion 312 is provided with an insulating through-hole for mounting the static contact portion 311 and the probe 321, an isolation portion is provided in the insulating through-hole. The static contact portion 311 is pressed against one side of the isolation portion, the probe reset spring 323 is pressed against the other side of the isolation portion, and the isolation portion is formed with a contact through-hole for the probe 321 to pass through for contact with the static contact portion 311.

In this embodiment, by providing an isolation portion at the static contact insulating portion 312, the insulating isolation and mating installation of the static contact portion 311 and the probe 321 are realized, so that the spring is compressed when the probe 321 is in contact with the material. Thus, the upper end of the probe 321 is contacted with the static contact portion 311 disposed on the upper side through the contact through-hole formed on the isolation portion, so as to form a closed circuit and generate a signal in the circuit board.

In some embodiments, the probe 321 includes a probe through-hole provided in an extension direction along the optical channel direction, the static contact portion 311 includes a static contact through-hole provided in an extension direction along the optical channel direction, and the optical channel includes the probe through-hole and the static contact through-hole.

In some embodiments, the probe device further includes a clamping portion 60. For example, the clamping portion 60 is a clamping handle for mounting the probe device on a CNC machining machine. In some embodiments, the clamping portion 60 is threaded to the housing 10′.

In some embodiments, the probe device further includes a power supply provided within the housing 10′ for supplying power to at least the circuit board 40. The housing 10′ encloses the light source assembly 20, the probe assembly 30, the circuit board 40 and the power supply in a space. To enable charging of the power supply, the circuit board 40 is also provided with a wireless charging circuit.

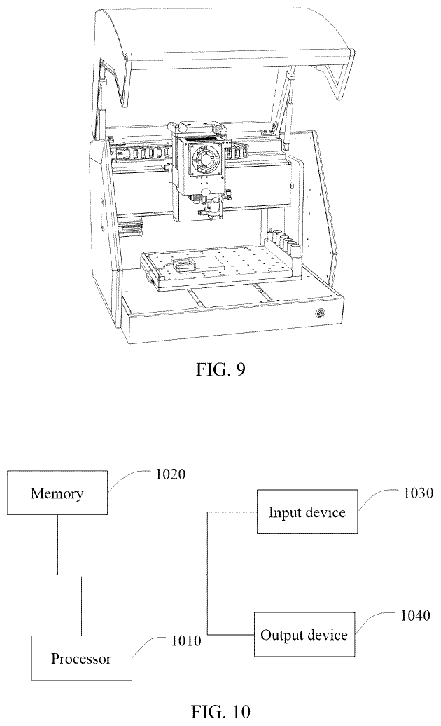

As shown in FIG. 9 and FIG. 8, embodiments of the application provide a numerically controlled machining apparatus, e.g., the numerically controlled machining apparatus is a 3D engraving device, and the numerically controlled machining apparatus is configured with the probe device of any embodiment of the present application.

In some embodiments, the probe 321 is in real-time contact and electrically conductive with the touch feedback signal-conducting metal sheet (3112—second probe electrode). The static contact portion 311 is in real-time contact and electrically conductive with the touch feedback signal-conducting metal sheet (3111—first probe electrode). The probe 321 is electrically insulated from the static contact portion 311 in normal conditions. The top of the probe 321 is at a certain insulating distance from the bottom of the static contact portion 311 under the action of a spring tension. The probe 321 can be moved upwardly in a vertical direction under the action of an external force upwardly from the bottom that can overcome the spring tension.

As the probe moves upward, at the moment when the top of the probe 321 contacts the bottom of the static contact portion 311, electrically conduction realizes. The feedback signal is transmitted in the external circuit connected to the first probe electrode 3111 and the second probe electrode 3112 contacting the feedback signal-conducting metal piece. When the external force on the bottom of the probe 321 is withdrawn, the top of the probe 321 is separated from the bottom of the static contact portion 311 under the tension of the probe reset spring 323 and electrically insulated, the circuit for transmitting the touch feedback signal is cut off, and the transmission of the signal is stopped.

The external force that causes the contact feedback signal is downward. In addition, the spring elasticity coefficient of the tool setter is larger than that of the probe device, so that when the two move in opposite directions and come into contact, the probe will first be squeezed to trigger the signal transmission, and then continue to move because the probe has already reached its limit position, thus the spring of the tool setter will be squeezed to trigger the signal transmission.

Because the transmission circuit of the touch trigger signal is an independent structure inside the probe, which is not related to external objects, the triggering and transmission of the signal do not need to pass through the detected material, so the material does not need to be limited to as conductive metal material.

The following describes the logic for automatically calculating the height of the upper surface of the material in the CNC machining apparatus of the present application in cooperation between the probe device and the tool setter:
1. The spindle of CNC machining apparatus clamps the probe device as a whole to move to the tool setter above so that the probe tip aligned with the center of the top surface platform of the tool setter and then slowly moved down.
2. With the two ends in contact the probe is squeezed and contracted to trigger a contact signal first, but the parameter corresponding to this signal is not involved in the logical calculation of this function. The tool setter then triggers the contact signal, from the parameter corresponding to this signal the Z-axis coordinates of the lower tip of the probe in the device's coordinate system at the time the touch signal has been triggered within itself can be calculated. From now on, no matter how the spindle moves with the probe in the coordinate system, this coordinate value can be calculated accurately and becomes a known quantity.
3. Next, the spindle carries the probe to the top of any desired point on the surface of the material, and then slowly moves down until the probe triggers a touch signal, at which time the Z-axis coordinate of the probe tip corresponding to the signal is the Z-axis coordinate of the probed point, and with this coordinate the height the machine workbench can also be calculated.
4. The above process is the logical principle for realizing the “Upper Probe+Lower Tool Setter Combination” method of measuring the upper surface of a material blank and measuring in any other application scenarios that require the measurement of a vertically probing point of an object on the Z-axis coordinate.

It should be noted that, for each of the foregoing method embodiments, for the sake of simplicity of description, they are all expressed as a series of actions combined, but the person skilled in the art should be aware that the present application is not limited by the order of the described actions, because according to the present application, some of the steps may be carried out in other order or at the same time. Secondly, the person skilled in the art should also be aware that the embodiments described in the specification are preferred embodiments, and the actions and modules involved are not necessarily necessary for the present application. In the above embodiments, the description of each embodiment has its own focus, and the parts that are not described in detail in a certain embodiment can be referred to the relevant descriptions of other embodiments.

FIG. 10 is a schematic diagram of a hardware structure of a computer apparatus for performing a method of controlling an engraving device provided in another embodiment of the present application. As shown in FIG. 10, the apparatus includes:
one or more processors 1010 and a memory 1020, with one processor 1010 being used as an example in FIG. 10.

The device for performing the control method for the engraving device may also include: an input device 1030 and an output device 1040.

The processor 1010, the memory 1020, the input device 1030, and the output device 1040 may be connected via a bus or otherwise, and connection via a bus is used as an example in FIG. 10.

The memory 1020 serves as a non-volatile computer-readable storage medium that can be used to store non-volatile software programs, non-volatile computer-executable programs, and modules, such as program instructions/modules corresponding to the control method for the engraving device of the present application embodiment. The processor 1010 executes various functional applications of the server and data processing by running the non-volatile software programs, instructions, and modules stored in the memory 1020, i.e., realizing the control method for engraving device of the above-described embodiments of methods.

The memory 1020 may include a storage program area and a storage data area, wherein the storage program area may store an operation system, an application program required for at least one function, and the storage data area may store data created in accordance with the use of the engraver control unit, among other things. Additionally, the memory 1020 may include a high-speed random access memory, and may also include a non-volatile memory, such as at least one disk memory device, a flash memory device, or other non-volatile solid state memory device. In some embodiments, the memory 1020 may optionally include memory set remotely relative to the processor 1010, and these remote memories may be connected to the control unit of engraving device via a network. Examples of the networks include, but are not limited to, the Internet, a corporate intranet, a local area network, a mobile communication network, and combinations thereof.

The input device 1030 may receive incoming numeric or character information, as well as generate signals related to user settings for the engraver control unit and function control. The output device 1040 may include a display device such as a display screen.

The one or more modules are stored in memory 1020 and, when executed by the one or more processors 1010, perform the control method for engraving device of any of the method embodiments described above.

The product can execute the method provided in the embodiments of the present application, with the corresponding functional modules and beneficial effects of executing the method. Technical details not exhaustively described in this embodiment can be found in the methods provided in the embodiments of this application.

The computer apparatus of embodiments of the present application exist in a variety of forms, including, but not limited to.
(1) Mobile communication devices characterized by mobile communication functions and are mainly aimed at providing voice and data communication. These terminals include smartphones (e.g., iPhone), multimedia phones, feature phones, and low-end cell phones.
(2) Ultra-mobile personal computer terminals which belong to the category of personal computers, with computing and processing functions, and generally also have mobile Internet characteristics. These terminals include PDAs, MIDs and UMPC devices such as the iPad.
(3) Portable entertainment devices, which can display and play multimedia content. Such devices include: audio and video players (e.g., iPods), handheld game consoles, e-books, as well as smart toys and portable car navigation devices.
(4) Servers that provides computing services. The composition of a server includes a processor, hard disk, memory, system bus, etc. A server is similar to a general-purpose computer architecture, but because of the need to provide highly reliable services, is therefore required to have high requirements in terms of processing power, stability, reliability, security, scalability, manageability, and so on.
(5) Other electronic devices with data interaction functions.

The above-described embodiments of the device are merely schematic, wherein the units illustrated as separated components may or may not be physically separated, and the components shown as units may or may not be physical units, i.e., they may be in one place or may be distributed to a plurality of network units. Some or all these modules can be selected to fulfill the purpose of the embodiment scheme according to the actual needs.

Through the above description of the embodiments, it is clear to those skilled in the art that the embodiments can be realized with the aid of software plus a general hardware platform, and of course also through hardware. Based on this understanding, the above technical solutions may be embodied in the form of a software product, which may be stored in a computer-readable storage medium, such as a ROM/RAM, a disk, a CD-ROM, or the like, and include a number of instructions to enable a computer device (which may be a personal computer, a server, or a network device, etc.) to perform the methods of various embodiments or certain portions of embodiments.

Finally, it should be noted that the above embodiments are only used to illustrate the technical solutions of the present application, not to limit them. Although the present application has been illustrated in detail with reference to the foregoing embodiments, a person of ordinary skill in the art should understand that it is still possible to modify the technical solutions recorded in the foregoing embodiments or replace some of the technical features therein with the same; and such modifications or replacements do not make the corresponding technical solutions depart from the spirit of the scope of the technical solutions of the embodiments of the present application. These modifications or substitutions do not cause the essence of the corresponding technical solutions to depart from the spirit and scope of the technical solutions of the embodiments of the present application.

I/We claim:

1. A control method for an engraving device, the engraving device comprising a head assembly and a workbench assembly, the head assembly being movable in a vertical direction and a transverse direction, and the workbench assembly being movable in a forward and backward direction, the vertical, transverse, and forward and backward directions being perpendicular to each other, and the workbench assembly being provided with a probe device and a tool; the method comprising:
controlling the head assembly to move over the probe device and to clamp the probe device from the probe base;
controlling the head assembly to carry the probe device to probe material to be processed to obtain material data, the material to be processed being secured to the workbench assembly;
controlling the head assembly to move the probe device to and into the probe base;
controlling the head assembly to move over the tool and to clamp the tool from the tool base; and
controlling the tool to engrave the material to be processed, based at least on the material data and tool path file.

2. The method of claim 1, wherein the workbench assembly is further provided with a tool setter, the method further comprising:
controlling the head assembly to carry the probe device vertically downward from a first predetermined height and record a first vertical travel distance when the probe device triggers the tool setter;
controlling the head assembly to carry the tool vertically downward from the first predetermined height and record a second vertical travel distance when the tool triggers the tool setter;
compensating the material data according to the first vertical travel distance and the second vertical travel distance for controlling the tool in conjunction with the tool path file to engrave the material to be processed.

3. The method of claim 2, further comprising determining a Z-axis coordinate transformation relationship: Zₘ=Z_{L}−Z_{w}; wherein.
Zₘ is the current mechanical coordinate in Z-axis; Z_{L} is the mechanical coordinate in Z-axis at the time the probe device detects the highest point on the surface of the material to be processed and is triggered; and Z_{w} is the current Z-axis working coordinate.

4. The method of claim 3, wherein said compensating the material data according to the first vertical travel distance and the second vertical travel distance comprises tool length compensation using the following equation:
Zₘ=Z_{L}−Z_{w}−Z_{OFFSET}; wherein Z_{OFFSET} is the difference between the first vertical travel distance and the second vertical travel distance.

5. The method of claim 2, wherein the material to be processed is secured to the workbench assembly by an L-shaped positioning base plate, the method further comprising:
determining the inner corner point of the L-shaped positioning base plate as the zero point of the L-shaped positioning base plate, and determining a first relative positional relationship between the zero point and a predetermined mechanical coordinate zero point of the workbench assembly;
obtaining input of origin of the work coordinate configuration data comprising a second relative positional relationship between origin of the work coordinate and the zero point of the L-shaped positioning base plate; and
determining an XY plane coordinate transformation relationship between the work coordinate and the mechanical coordinate based on the first relative positional relationship and the second relative positional relationship.

6. The method of claim 5, wherein said controlling the cutter in conjunction with the cutter path file to engrave the material to be processed comprises:
obtaining current work coordinates based on the tool path file;
determining current mechanical coordinates based on the transformation relationship between the current work coordinates and the XY plane coordinate;
controlling the head assembly carrying the tool to move to the current mechanical coordinates to engrave the material to be processed.

7. The method of claim 5, wherein
the first relative positional relationship comprises a distance in the X-axis direction between the zero point of the L-shaped positioning base plate and the origin of the mechanical coordinates, a distance in the Y-axis direction between the zero point of the L-shaped positioning base plate and the origin of the mechanical coordinates; and
the second relative positional relationship comprises a distance in the X-axis direction between the origin of the work coordinate and the zero point of the L-shaped positioning base plate, and a distance in the Y-axis direction between the zero point of a work coordinate and the zero point of the L-shaped positioning base plate.

8. The method of claim 7, wherein the XY plane coordinate transformation relationship is expressed as the following equation:
Xₘ=X_{L}−X_{w}−X_{offset}; Yₘ=Y_{L}−Y_{w}−Y_{offset}, wherein
X_{L} is the distance in the X-axis direction between the zero point of the L-shaped positioning base plate and the origin of the mechanical coordinates;
Y_{L} is the distance in the Y-axis direction between the zero point of the L-shaped positioning base plate and the origin of the mechanical coordinates;
X_{offset} is the distance in the X-axis direction between the zero point of the working coordinates and the zero point of the L-shaped positioning base plate;
Y_{offset} is the distance in the Y-axis direction between the zero point of the working coordinates and the zero point of the L-shaped positioning base plate;
(X_{w}, Y_{w}) is the current work coordinate; (Xₘ, Yₘ) is the current mechanical coordinate.

9. The method of claim 5, further comprising pre-storing mechanical coordinates of the probe device and the tool for controlling movement of the head assembly to the probe device or the tool.

10. A computer apparatus comprising a memory, a processor, and a computer program stored in the memory, wherein the processor executes the computer program to implement the steps of the method of claim 1.

11. An engraving device comprising:
a computing device as claimed in claim 10;
a head assembly being movable in a vertical and lateral direction;
a workbench assembly being movable in a forward and backward direction, the vertical, lateral, and the forward and backward directions being perpendicular to each other, the workbench assembly being provided with a probe device and a tool.

12. The engraving device of claim 11, wherein the workbench assembly is further provided with a tool setter.

13. A computer readable storage medium having stored therein a computer program/instruction, wherein the computer program/instruction implements the steps of the method of claim 1 when executed by a processor.

14. A computer program product comprising a computer program/instruction, wherein the computer program/instruction implements the steps of the method of claim 1 when executed by a processor.
